(19) United States
(12) Patent Application Publication
(10) Pub. No.: US 2018/0354429 A1
(43) Pub. Date: Dec. 13, 2018

(54) METHOD FOR PRODUCING AN ACOUSTIC PROTECTION PANEL INTENDED TO BE FITTED FACING A NOISY AND HOT SOURCE OF A VEHICLE

(71) Applicant: CERA APS, Reims (FR)

(72) Inventors: Laurent Waxin, Dravegny (FR); Olivier Vitrant, Reims (FR)

(21) Appl. No.: 15/573,567

(22) PCT Filed: May 12, 2016
(86) PCT No.: PCT/FR2016/051130

§ 371 Date: Nov. 13, 2017

(30) Foreign Application Priority Data
May 13, 2015 (FR) 1554307

(51) Int. Cl. B60R 13/08

(52) U.S. Cl. CPC B60R 13/0815; B60R 13/0876

(57) ABSTRACT

A method for producing a vehicle acoustic protection panel, comprising producing a screen comprising two parts in a first mould by thermocompression, the parts having a first configuration enabling them to be released from the mould, the parts each comprising a fibrous and porous thermal insulation layer and a heat-reflecting metal sheet made of aluminium, placing in juxtaposition the parts side by side in a second mould, of which a moulding cavity corresponds to the geometry of the panel to be obtained, the parts can be pressed firmly against the wall of the moulding cavity, adopting a second configuration corresponding to the panel geometry, the fibrous layer facing towards the inside of the moulding cavity, injecting in the moulding cavity a mixture that is a precursor of foam, forming a core overmoulding the fibrous layer, after the foam has expanded, releasing the panel obtained from the mould.

### BACKGROUND

The invention relates to a method for producing an acoustic protection panel intended to be fitted facing a noisy and hot source of an automotive vehicle and a panel obtained by such a method.

It is known to implement a method for producing an acoustic protection panel intended to be fitted facing a noisy and hot source of a vehicle, said method comprising the following steps:
producing a screen in a first mould by thermocompression, said screen comprising a fibrous and porous thermal insulation layer and a heat-reflecting metal sheet—in particular made of aluminium,
placing said screen in a second mould of which the moulding cavity corresponds to the geometry of said panel that is to be obtained, said fibrous layer facing towards the inside of said cavity,
injecting into said cavity a mixture that is a precursor of foam, so as to form a core overmoulding said fibrous layer,
after the foam has expanded, releasing said panel obtained from the mould.

The thermal protection screen is intended to protect the core of the heat released by the source.

The fact that it is produced by thermocompression implies a limitation to the geometry which can be given to it, the moulded core however being able to adopt a complex geometry, adapted, in particular, to the geometry of the source.

In particular, it can prove to be impossible to protect the edge of the core, which obliges to design a panel wherein the core is equipped, in its periphery, with a chamfer avoiding its edge being exposed to heat.

It results in a reduced capacity of the core to ensuring its acoustic absorption function.

### SUMMARY

The invention aims to overcome this disadvantage.

To this end, and according to a first aspect, the invention proposes a method for producing an acoustic protection panel intended to be fitted facing a noisy and hot source of a vehicle, said method comprising the following steps:
producing a screen comprising two parts in a first mould by thermocompression, said parts being arranged relative to each other according to a first configuration enabling them to be released from the mould, said parts each comprising a fibrous and porous thermal insulation layer and a heat-reflecting metal sheet—in particular made of aluminium,
placing in juxtaposition said parts side by side in a second mould, of which the moulding cavity corresponds to the geometry of said panel to be obtained, so that said parts can, by being pressed firmly against the wall of said cavity, adopt a second configuration corresponding to said geometry, said fibrous layer facing towards the inside of said cavity,
injecting in said cavity a mixture that is a precursor of foam, so as to form a core overmoulding said fibrous layer,
after the foam has expanded, releasing said panel obtained from the mould.

With such a method, the screen is produced by thermocompression in a first configuration chosen to enable it to be released from the mould, said screen then being overmoulded by the core to be placed in the second configuration corresponding to that which it adopts once integrated in the panel.

A geometry can thus be given to the screen, which would not have been able to be produced if the first mould, serving as its thermocompression, had been conform according to the second configuration which would have prevented—or at least really hindered—it being released from the mould, for example, by the absence of any clearance—even by the existence of an undercut.

In particular, it is possible to protect the edge of the core, which avoids the production of a chamfer in its periphery, and therefore optimises the acoustic absorption properties of said core.

According to a second aspect, the invention proposes a panel obtained by such a method.

### BRIEF DESCRIPTION OF THE DRAWINGS

Other particularities and advantages of the invention will appear in the description which follows, made in reference to the appended figures, wherein:

FIG. 1 is a schematic cross-section representation of a panel according to the first embodiment,

FIG. 2 is a schematic cross-section representation of the screen of the panel in FIG. 1, represented from the thermocompression step, in a configuration enabling it to be released from the mould,

FIG. 3 is a schematic cross-section representation of a panel according to a second embodiment,

FIG. 4 is a schematic cross-section representation of the panel in FIG. 3, represented from the thermocompression step, in a configuration enabling it to be released from the mould.

### DETAILED DESCRIPTION

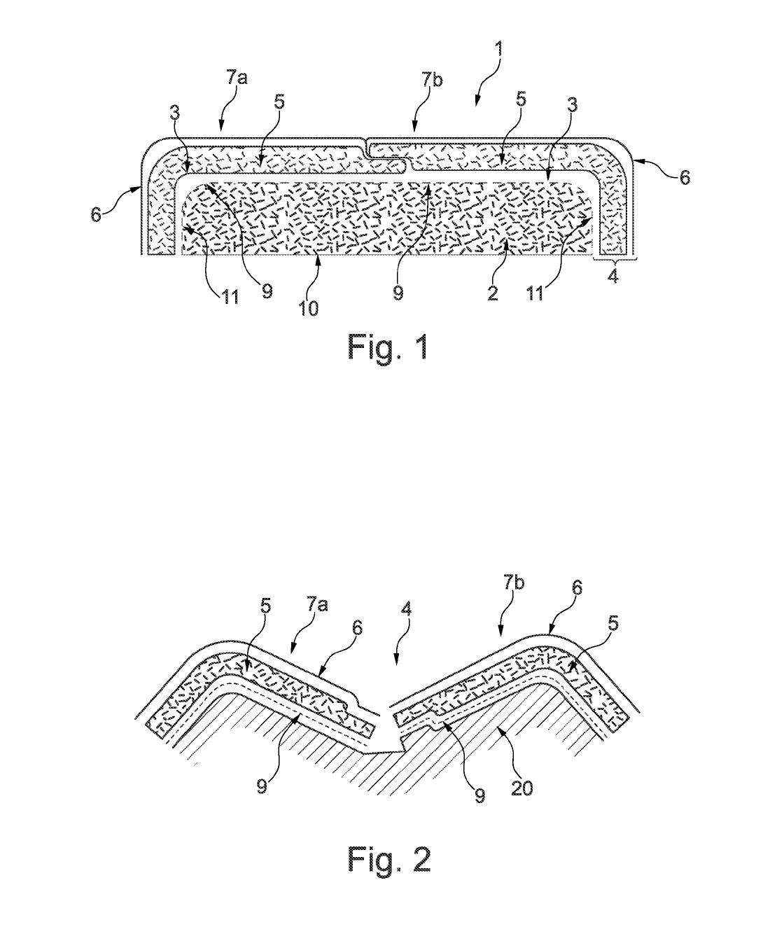

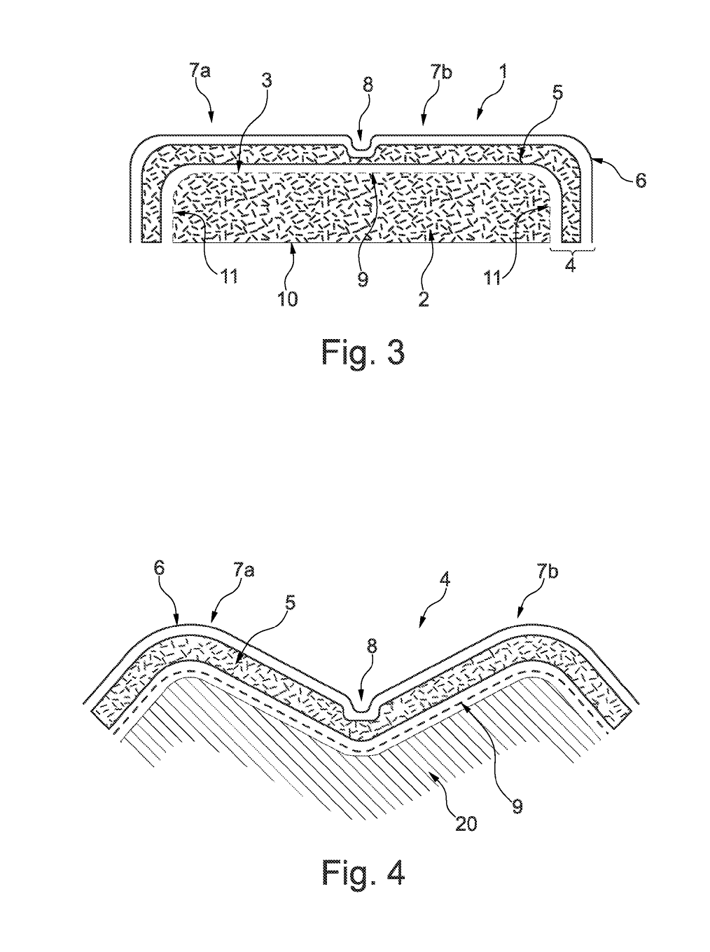

In reference to the figures, a method of an embodiment of an acoustic production panel 1 intended to be fitted facing a noisy and hot source of a vehicle has been defined, said method comprising the following steps:
producing a screen 4 comprising two parts 7a, 7b in a first mould 20 by thermocompression, said parts being arranged relative to each other according to a first configuration (FIGS. 2 and 4) enabling them to be released from the mould, said parts each comprising a fibrous and porous thermal insulation layer 5 and a heat-reflecting metal sheet 6—in particular made of aluminium,
placing in juxtaposition said parts side by side in a second mould, of which the moulding cavity corresponds to the geometry of said panel to be obtained, so that said parts can, by being pressed firmly against the wall—in particular, because of the push exerted by the foam—of said cavity, adopting a second configuration (FIGS. 1 and 3) corresponding to said geometry, said fibrous layer facing towards the inside of said cavity,
injecting in said cavity a mixture that is a precursor of foam, so as to form a core 2 overmoulding said fibrous layer,
after the foam has expanded, releasing said panel obtained from the mould.

According to the embodiment represented in FIG. 1, the two parts 7a, 7b are separate and arranged side by side, overlapping.

In particular, the fibrous layer 5 is further compressed in each part 7a, 7b in the overlapping zone so as to avoid excess thickness of the screen 4 in said zone.

According to the embodiment represented in FIG. 3, the two parts 7a, 7b are a single-piece, the thermocompression producing a tapered, rectilinear zone 8 where the fibrous layer 5 is further compressed, so as to form a flexible hinge enabling an angular articulation of said parts relative to each other, to pass from the first to the second configuration of the screen 4.

A panel 1 has now been defined, produced by such a process, said panel comprising, arranged on top of each other:
a porous polyurethane foam-based moulded core 2, so as to enable an acoustic absorption of the noise coming from said source, said core having a face 3 intended to be facing towards said source,
a thermos-compressed thermal protection screen 4, covering at least a part of said face,
said screen comprising:
a fibrous and porous thermal insulation layer 5, said layer being overmoulded by said core,
a heat-reflecting metal sheet 6—in particular made of aluminium,
said screen being produced in at least two parts 7a, 7b arranged in juxtaposition side by side so as to ensure a continuous thermal protection of two adjacent zones of said face.

According to the embodiments represented, the screen 4 extends over the edge 11 of the core 2.

According to the embodiment represented in FIG. 1, the two parts 7a, 7b are separate and arranged side by side, overlapping.

According to the embodiment represented in FIG. 3, the two parts 7a, 7b are a single-piece, said parts being connected to each other by the intermediary of a tapered, rectilinear zone 8 where the fibrous layer 5 is further compressed, so as to form a flexible hinge enabling an angular articulation of said parts relative to each other before their overmoulding by the core 2.

According to an embodiment, the foam of the core 2 has a resistance to the passage of air of between 1000 and 1500 N.s.m⁻³.

According to an embodiment, the foam of the core 2 has a density of between 0.22 and 0.28, and in particular, between 0.23 and 0.27.

A foam equipped with such air passage resistance and density characteristics is usually used to produce acoustic protection panels intended to be protected from a noisy and hot source.

According to an embodiment, the fibres of the fibrous layer 5 are mineral fibres—in particular, glass, silicon or rock, the fibre type being chosen according to the expected thermal conductivity characteristics for said layer.

According to an embodiment, the fibrous layer 5 has a thermal conductivity of between 0.055 and 0.061 W.m⁻¹.K⁻¹ at 200° C., and in particular, between 0.057 and 0.059 W.m⁻¹.K⁻¹.

According to an embodiment, the fibrous layer 5 has a resistance to the passage of air lower than 4000 N.s.m⁻³.

According to an embodiment, the fibrous layer 5 has a thickness of between 3 and 6 mm.

According to an embodiment, the fibrous layer 5 has a surface mass of between 600 and 1000 g/m².

According to an embodiment, the fibres of the fibrous layer 5 are connected to each other by a resin, in particular, thermosetting, for example, phenolic.

In this case, the connection between the sheet 6 and the fibrous layer 5 can be ensured by the resin.

According to another embodiment, the fibres of the fibrous layer 5 are connected to each other by needling without adding any resin, which facilitates the recycling of the panel 1 at end-of-life.

According to the embodiments represented, the fibrous layer 5 is coated with a non-woven dividing layer 9, being interposed between said fibrous layer and the core 2.

Such a non-woven layer 9 enables, in particular, to facilitate the screen 4 being released from the mould, following its production by thermocompression.

In a way not represented in a figure, the metal sheet 6 can be equipped with a plurality of micro-perforations, the surface density of micro-perforations being, in particular, between 400,000 and 600,000 micro-perforations per m².

The presence of such micro-perforations enables sound waves to cross the metal sheet 6 to be absorbed by the insulation layer 5 and by the core 2.

According to an embodiment, the metal sheet 6 has a thickness of between 50 and 150 microns, and, in particular, between 70 and 100 microns, a thickness that is small contributing to the reduction of the screen 4.

In a way not represented in a figure, the sheet 6 can be embossed so that it can be stretched.

According to the embodiments represented, the core 2 has an opposite face 10 to the face 3 intended to be exposed to the source, said opposite face having no watertight coating, so as to optimise the expected acoustic absorption.

1. A method for producing an acoustic protection panel intended to be fitted facing a noisy and hot source of a vehicle, said method comprising the following steps:
producing a screen comprising two parts in a first mould by thermocompression, said parts being arranged relative to each other according to a first configuration enabling them to be released from the mould, said parts each comprising a fibrous and porous thermal insulation layer and a heat-reflecting metal sheet made of aluminium,
placing in juxtaposition said parts side by side in a second mould, of which a moulding cavity corresponds to the geometry of said panel to be obtained, so that said parts can, by being pressed firmly against the wall of said moulding cavity, adopting a second configuration corresponding to said geometry, said fibrous layer facing towards the inside of said moulding cavity,
injecting in said moulding cavity a mixture that is a precursor of foam, so as to form a core overmoulding said fibrous layer,
after the foam has expanded, releasing said panel obtained from the mould.

2. The method according to claim 1, wherein the two parts are separate and arranged side by side, overlapping.

3. The method according to claim 1, wherein the two parts are a single-piece, the thermocompression producing a tapered, rectilinear zone where the fibrous layer is further compressed, so as to form a flexible hinge enabling an angular articulation of said parts relative to each other, to pass from a first to a second configuration of the screen.

4. A panel produced by a method according to claim 1, said panel comprising, arranged on top of each other:
a porous polyurethane foam-based moulded core, so as to enable an acoustic absorption of a noise coming from a source, said core having a face configured facing towards said source,
a thermo-compressed thermal protection screen, covering at least a part of said face,
said screen comprising:
a fibrous and porous thermal insulation layer, said layer being overmoulded by said core,
a heat-reflecting metal sheet made of aluminium,
said screen being produced in at least two parts arranged in juxtaposition side by side so as to ensure a continuous thermal protection of two adjacent zones of said face.

5. The panel according to claim 4, wherein the screen extends over an edge of the core.

6. The panel according to claim 4, wherein the two parts are separate and arranged side by side, overlapping.

7. The panel according to claim 4, wherein the two parts are a single-piece, said parts being connected to each other by the intermediary of a tapered, rectilinear zone where the fibrous layer is further compressed, so as to form a flexible hinge enabling an angular articulation of said parts relative to each other before an overmoulding of the core.

8. The panel according to claim 4, wherein the foam of the core has a resistance to the passage of air of between 1000 and 1500 N.s.m⁻³.

9. The panel according to claim 4, wherein the fibres of the fibrous layer are mineral fibres, selected from the group consisting of a glass, a silicon and a rock.

10. The panel according to claim 4, wherein the fibrous layer is coated with a non-woven dividing layer, being interposed between said fibrous layer and the core.
